(19) United States
(12) Patent Application Publication
(10) Pub. No.: US 2013/0275186 A1
(43) Pub. Date: Oct. 17, 2013

(54) Merchant Benchmarking Tool

(71) Applicant: Visa U.S.A. Inc., San Francisco, CA (US)

(72) Inventors: Jeffrey Rolland Olives, Danville, CA (US); Jay Allen DeWitt, Spokane, WA (US); Dennis Norman Moser, Atherton, CA (US); James C. Salters, Cincinnati, OH (US); Laura DiGioacchino, San Mateo, CA (US); Alex Epelman, Redwood City, CA (US)

(21) Appl. No.: 13/837,645

(22) Filed: Mar. 15, 2013

Related U.S. Application Data
(63) Continuation-in-part of application No. 12/191,796, filed on Aug. 14, 2008.
(60) Provisional application No. 60/955,856, filed on Aug. 14, 2007.

(51) Int. Cl. G06Q 10/06

(52) U.S. Cl. CPC G06Q 10/06393
USPC 705/7.39

(57) ABSTRACT

A benchmarking tool accesses a database comprising a plurality of transaction records, each of the records comprising transaction data on a purchase transaction. A first subset of the transaction records is determined that occur within a predetermined time period and are associated with a first merchant. A second subset of the transaction records is determined that occur within the predetermined time period and are associated with a merchant peer group. The first subset of transaction records are processed to determine a first metric for the first merchant. The second subset of transaction records are processed to determine a second metric for the merchant peer group. The first metric is compared to the second metric to indicate performance of the first merchant relative to performance of the merchant peer group.

### CROSS-REFERENCES TO RELATED APPLICATIONS

This application is a continuation-in-part of U.S. Non-provisional patent application Ser. No. 12/191,796, filed Aug. 14, 2008, entitled “Merchant Benchmarking Tool,” which claims priority to, and the benefit of, U.S. Application Ser. No. 60/955,856, filed Aug. 14, 2007, entitled “Merchant Benchmarking Tool.” The entire contents of each of which is hereby incorporated by reference.

### FIELD

Various implementations, and combinations thereof, are related to data analysis tools, more particularly data analysis tools useful in the payment processing industry, and most particularly to data analysis tools that compares a sales performance of a merchant to that of peers of the merchant.

### COPYRIGHT

Contained herein are materials subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

A merchant, such as a retailer, may collect point of sale information on transactions conducted between the merchant and consumers purchasing goods or services of the merchant. The point of sale information may assist the merchant to determine the amount of sales that the merchant may have had during a time interval. The point of sale information may reveal to the merchant that some goods or services are more frequently sold than others.

However, it may be difficult for the merchant to quantitatively evaluate how sales of the merchant compare to the sales of peers of the merchant. Generally, the merchant does not have access to purchasing histories or purchasing trends of consumers across multiple merchants within a market in which the merchant is a member. Moreover, such purchasing histories or purchasing trends may not be organized in a way for the merchant to be able to evaluate their relevance to a consumer base of the merchant. Organized information about sales within the market of the merchant may assist the merchant in evaluating its marketing and payment programs, such as targeted marketing programs, loyalty programs, store/site design, merchandising and category management, pricing, or other such promotions of the merchant.

The foregoing points out a need to provide performance measures of sales of the merchant.

### SUMMARY

In one implementation, a computer implemented method is disclosed wherein data is accumulated from a plurality of cashless sales transactions each of which is conducted on a corresponding account issued to a consumer by an issuer within a payment processing system. The payment processing system includes a transaction handler processing the transactions for both the merchant and processing other of the transactions for other merchants (e.g., peers of the merchant). The merchant and the other merchants submit a corresponding transaction to a corresponding acquirer for processing by the transaction handler. The transaction handler requests the issuer of the corresponding account to obtain payment for the transaction from the corresponding account and for which the issuer forwards the payment to the transaction handler who forwards the payment to the acquirer to pay the merchant for the corresponding transaction. A percentage change in the transactions of one of the merchants in a category is calculated from the accumulated data for a current time period as compared with a past time period. A percentage change in the transactions of the other merchants in the category is also calculated from the accumulated data for the current time period as compared with the past time period. A report is rendered showing: the percentage change for the one merchant in the category and the percentage change for the other merchants in the category. The rendered report identifies growth in cashless sales of the merchant within the category compared to the cashless sales of the other merchants in the category.

In a further example, a benchmarking tool accesses a database comprising a plurality of transaction records, each of the records comprising transaction data on a purchase transaction. A first subset of the transaction records is determined that occur within a predetermined time period and are associated with a first merchant. A second subset of the transaction records is determined that occur within the predetermined time period and are associated with a merchant peer group. The first subset of transaction records are processed to determine a first metric for the first merchant. The second subset of transaction records are processed to determine a second metric for the merchant peer group. The first metric is compared to the second metric to indicate performance of the first merchant relative to performance of the merchant peer group.

### BRIEF DESCRIPTION OF THE DRAWINGS

Implementations will become more apparent from the detailed description set forth below when taken in conjunction with the drawings, in which like elements bear like reference numerals.

FIG. 1 depicts a block diagram illustrating an exemplary system for a merchant to receive analyzed data from a merchant benchmarking tool;

FIG. 2 depicts an exemplary memory sector having fields that store indicia of a transaction within the system of FIG. 1;

FIG. 3 depicts an exemplary Venn Diagram showing sets, subsets, and sub-subsets of stored transaction data that may be stored in the exemplary memory sector of FIG. 2;

FIGS. 4 and 5 each depict portions of an Overall Sales and Marketing Performance Report created by an exemplary merchant benchmarking tool and showing metrics for a merchant and its peers;

FIGS. 6, 7 and 8 each depict portions of an Existing Customer Report created by an exemplary merchant benchmarking tool and showing metrics for a merchant and its peers;

FIGS. 9 and 10 each depict portions of a New Customer Report created by an exemplary merchant benchmarking tool and showing metrics for a merchant and its peers;

FIG. 11 depicts a flowchart of an exemplary method for rendering a report of an exemplary merchant benchmarking tool for delivery to a merchant; and

FIG. 12 depicts a block diagram of an exemplary payment processing system.

### DETAILED DESCRIPTION

A merchant benchmarking tool (MBT) is described. The MBT accesses transaction data of multiple merchants, analytically processes the transaction data, and provides particularly formatted outputs, such as electronically generated reports. The outputs can compare metrics describing sales (e.g., sales of transactions) of one of the merchants against peers of the merchant across various segments (e.g., inventory markets, merchant size, consumer groups). The outputs may assist the merchant to evaluate business goals of the merchant, such as sales performance (e.g., sales growth and market share, new and existing customer base, and average ticket), marketed targets, or loyalty programs, for example. The MBT can provide the merchant with outputs for spend analysis, performance gauges, rate of return, and customer purchasing performance (e.g., purchase frequency, retention, and share of wallet) within a market.

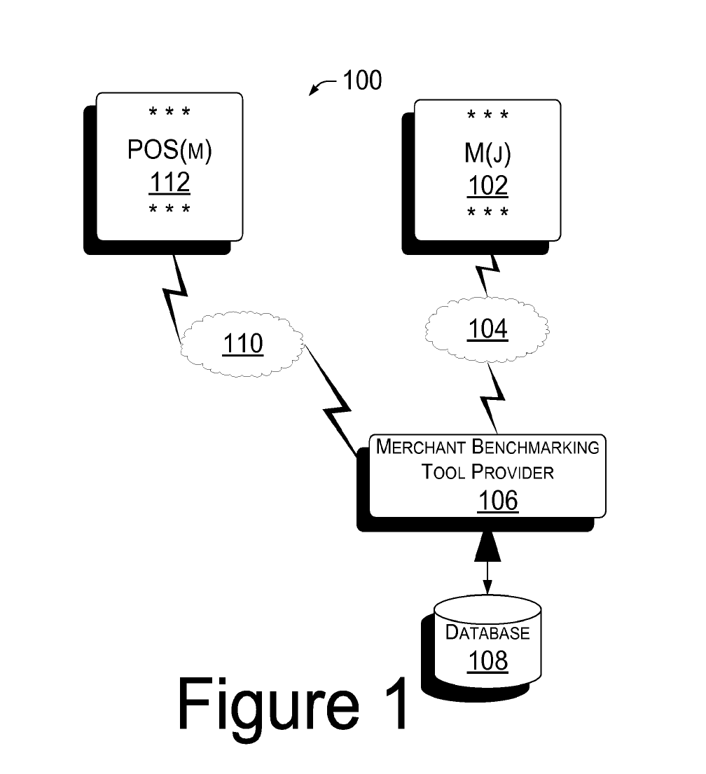

Referring to FIG. 1, a merchant benchmarking tool provider (MBTP) 106 provides multiple merchants M(1 to J) 102 access to the MBT, an output of the MBT, or a combination thereof via a network 104. As seen in FIG. 1, each merchant M(j) 102 of multiple merchants M(1 to J) 102 is represented by the M(j) 102, where j can be a value from 1 to J. The merchant M(j) 102 may be a person or entity that sells an inventory such as a good, a service, or a combination thereof. Examples of the merchant M(j) 102 can include: a manufacturer, a distributor, a retailer, a load agent, a service provider, or a healthcare provider. In a business-to-business setting, a second of the merchants M(j−3) 102 may be a consumer making a purchase from a first of the merchants (j) 102. The MBTP 106 may include a computer hosting computer code that, when executed, performs the functions of the MBT. The computer may be communicatively linked to a database 108 storing the transaction data of multiple merchants such as the merchants M(1 to J) 102.

The MBT may have an interactive user interface allowing for data entry such as information about the merchant M(j) 102. The MBT can then utilize the inputted information along with other information to which the MBT has access, such as payment processing industry information or consumer transaction histories in the database 108 to create the reports (e.g., sales volume, new customer, existing customer reports). Optimization, data mining algorithms, relational database filtering algorithms, and other formulaic derivations can be utilized by the MBT to produce such reports. The MBT may be accessible offline or online, such as via the Internet or other networks. The MBT can also benchmark at the individual store or group of stores level.

The transaction data used by the MBT can be acquired from a single data source or a combination of data sources. The data source can be the transaction data obtained from each of a Point of Service terminal (POS). Here, a POS(m) 112 can be, for example, a payment card reader, a dispensing machine, a check reader, a cash register, an Automated Teller Machine, a handheld terminal wirelessly connected to a merchant computer, an interactive kiosk, or a computer code such as a computer program that is stored in a memory of: a computer, a cellular phone, a personal digital assistant (PDA), or a combination thereof. POS(m) 112 can correspond to merchants, including the merchants M(1 to J) 102 or other merchants that are not among the merchants M(1 to J) 102. One of the merchants having the POS(m) 112 may engage in one of the transactions with a consumer for inventory using the POS(m) 112 to capture or create the transaction data associated with the transaction. As seen in FIG. 1, each POS(m) 112 of multiple merchants is represented by the POS(m) 112, where m can be a value from 1 to M. The POS(m) 112 may form a first transmission having the transaction data for the transaction that can be delivered to MBTP 106 through a network 110 that may be the same network as the network 104.

Functions of the MBTP 106 may be performed by a bank, a financial institution, an issuer, an acquirer, or a transaction handler. In one implementation, the MBT can automatically generate and transmit the transaction data on the transactions that are processed within at least one payment processing system (e.g., a Visa, MasterCard, or American Express network). Processing the transactions in the payment processing system may include the merchant submitting transmissions to the transaction handler in the payment processing system via an acquirer of the merchant. For example, the merchant may obtain information about the account of the consumer, such as an account number of the account, at the POS(m) 112, and submit an authorization request to the acquirer. Upon receiving an authorization response to the authorization request indicating that an issuer that has issued the account has authorized the account as valid and has having enough funds, the merchant may transfer the goods or services of the merchant being purchased to the consumer. Thereafter, the merchant may initiate remittance of each of the transactions by submitting a clearing or settling request to the transaction handler via the acquirer. Clearing includes the exchange of financial information between the issuer and the acquirer. Settlement includes the transfer of funds.

Within the payment processing system, the consumer may be identified by the corresponding account of the consumer. For example, Ms. Mary Smith may have the account number “4234567890123456” associated with the account of Ms. Mary Smith. Consequently, if one of the transactions is payable upon “4234567890123456,” then it can be determined that Ms. Mary Smith engaged in a transaction with one of the merchants in the payment processing system. A single account may have multiple account numbers, each associated with a corresponding one of the consumers that has rights to the account (e.g., joint account or corporate account with employees each having rights to conduct transactions upon the corporate account). In some cases, a plurality of the consumers may be associated with one of the accounts and the account may only have one account number. In such cases, each of the plurality of the consumers associated with the one account may be distinguished in other ways, such as via other data associated with the transaction. For example, if a magnetic stripe card associated with the one of the accounts is swiped at one of the POS(m) 112, track data stored in a band of magnetic material on the card may be sent via the network 110 and become part of the transaction data stored in the database 108. The track data may have the account number, an expiration date, a card verification value (CVV), a promotion code, a consumer identification code, or other data. Consequently, in this example, the consumer identification code from the track data can be used to distinguish one consumer from others who are associated the same account.

Other transaction data that can be stored in the database 108 may include the transaction data that includes aggregate sales information associated with purchases made within a market such as total cash sales in a women's clothing market for the year of 2007. Yet other transaction data stored in the database 108 may be that of a merchant that is anonymous but that is classified within a category, such as “sporting goods” retailer.

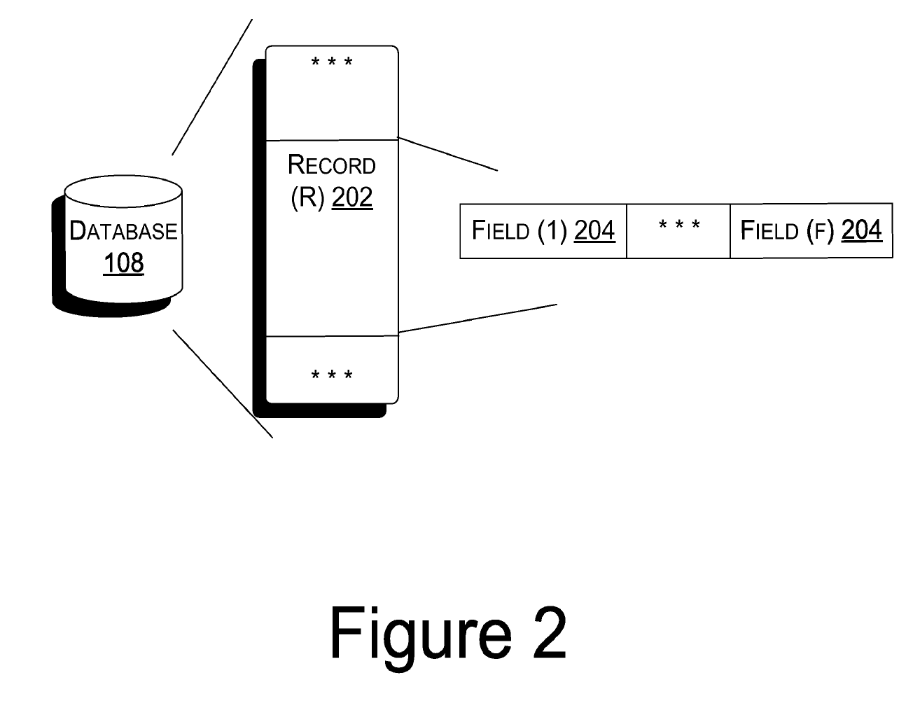

Referring to FIG. 2, the database 108 may be a relational database having records (1 to R) 202. The structure of the relational database may be serial, vertical, or another data structure known to a person of ordinary skill in the art. Each of the records (r) 202 within the database 108 may have corresponding fields (1 to F) 204. In one implementation, the record (r) 202 may store the transaction data received from the POS(m) 112 during a transaction conducted between the merchant M(j) 102 and the consumer for the purchase of inventory of the merchant M(j) 102. The fields (1 to F) 204 may include the transaction data for the one transaction. For example, the fields (1 through 8) 204 can include: an “amount field” such as the field (1) 204, to store an amount of funds to be transferred (authorized to be transferred from an account) or already transferred (e.g., Electronic Funds Transfer, cash, or cashless) from the consumer to the merchant M(j) 102; a “date field,” such as the field (2) 204 storing a date on which the transaction between the merchant and the consumer occurred; a “hour field,” such as the field (3) 204, to store the hour and minute that the transaction occurred (e.g., allowing determination of whether a consumer visits a merchant more than once a day); a “consumer identifier field,” such as the field (4) 204, to store the consumer identifier code of the consumer, such as a name of the consumer; an “account identifier field,” such as the field (5) 204, to store an account identifier of the account from which funds can be transferred; a “merchant identifier field”, such as the field (6) 204, to store a merchant identifier that uniquely distinguishes the merchant from among a plurality of merchants; a “merchant category field,” such as the field (7) 204, to store the merchant category of the merchant that engaged in the transaction with the consumer; or “product field,” such as the field (8) 204, to store a Universal Product Code (UPC) of the inventory purchased. Some fields(j) 204 can be empty such that no data is stored therein.

The merchant category of the merchant M(j) 102 may be stored in the database 108 or derived from the transaction data stored in the database 108. For example, the merchant identifier that is uniquely associated with the corresponding merchant is usable to determine at least one category that the corresponding merchant may be classified under. To illustrate, the merchant M(j) 102 may be a group of stores organized as a single franchise of retail clothing business entity (e.g., Saks Fifth Avenue) or a single store that may be a franchisee of the franchisor (e.g., a Saks Fifth Avenue® store 9999 located in Los Angeles) having the corresponding merchant identifier (ID) “RETCL4456.” The ID RETCL4456 can be used, such as via an algorithm or a look up table, to determine that the merchant M(j) 102 is classified as being in the following sample categories: Retailer, Clothing Store, High End Store, Women's Clothing Store, Store Located on Rodeo Drive, or combinations thereof. The merchant identifier may be a single string of alphanumeric data, a hashed code, or a series of text such as: a name, an address, and a phone number of the merchant M(j) 102.

The merchant category of the merchant M(j) 102 may be preset by the MBTP 106, specified by the merchant M(j) 102, or a combination thereof. For example, the merchant M(j) 102, such as Costco, may send a request to the MBTP 106 for a report of the MBT that will show other merchants that are classified in the same merchant category with Costco (i.e., Sam's Club or other such wholesale retailers).

The categories may be in different segments:
Organizational type
   Public and private corporations
   State and federal government
   City and county government
   Universities
   School districts
Market size
   Fortune 500 (annual revenue equal or above $2 billion)
   Large market (annual revenue equal or above $250 million but below $2 billion)
   Middle market (annual revenue equal or above $10 million but below $250 million)
   Small market (annual revenue less than $10 million)
Industry
   Manufacturing
   Finance, insurance, banking, and real estate
   Wholesale and retail trade
   Software and Information Technology solutions
   Transportation, warehousing, and delivery services
   Telecommunications, media, and entertainment
   Agricultural, mining, and construction
   Professional, scientific, and technical services
   Utilities
   Retailers
   Other services (e.g., food services, spa services, salon services, etc.)

The MBT can create sets, subsets, or sub-subsets of the transaction data stored in the database 108. The sets, subsets, or sub-subsets can be created by, for example, filtering the transaction data using the field (f) 204, such as the “merchant identifier field,” the “merchant category field,” or the “account identifier field” described in the example above or multiple of the fields (f, f+1, . . . f+n) 204. For example, a subset can be created using the “merchant category field” and the “account identifier field.”

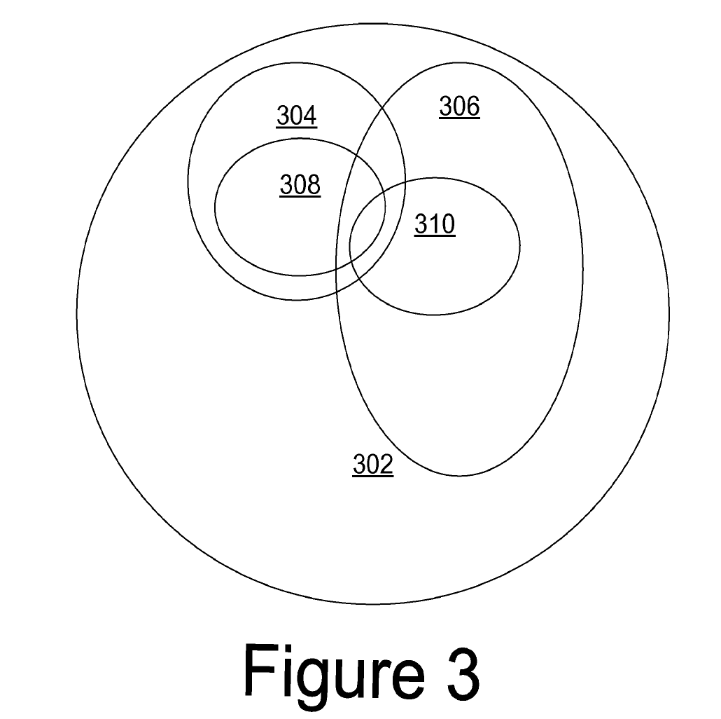

Referring to FIG. 3, in one implementation, the transaction data, shown in FIG. 3 as a transaction data 302, can be filtered to create two sets of the transaction data stored in the database 108: a first set 304 of the transaction data 302 in which the merchant M(j) 102 is the merchant engaged in each of the transactions in the first set 304, and a second set 306 of the transaction data 302 in which each of a plurality of the merchants are engaged in the transactions in the second set 306 and are each classified in at least one merchant category corresponding to a merchant category of the merchant M(j) 102.

For example, the first set 304 can be created by filtering the transaction data stored in the database 108 based on the corresponding merchant identifier of the merchant M(j) 102. Consequently, if the merchant identifier of the merchant M(j) 102 is “RETCL4456” then each record (r) 202 in the first set 304 of the transaction data 302 of the merchant M(j) 102 may have the ID “RETCL4456” in the corresponding “merchant identifier field” of the record (r) 202. The “merchant category field” in each record (r) 202 in the first set 304 may also indicate at least one merchant category that the merchant M(j) 102 may be in, such as “Retail Women's Clothing.” Alternatively, or in combination, the merchant identifier of the merchant M(j) 102 may be sufficient to derive at least one of the merchant categories of the merchant M(j) 102 such that the at least one merchant category of the merchant M(j) 102 need not be stored in the record (r) 202.

Similarly the second set 306 can be created by filtering the transaction data 302 based on the merchant category of each of the merchants engaged in the corresponding transactions in the second set 306. For example, each of the merchants in the second set 306 may be classified under a merchant category that matches the merchant category of the merchant M(j) 102. Consequently, if the at least one merchant category of the merchant M(j) 102 is “Retail Women's Clothing” then each merchant in the second set 306 is also classified at least under the merchant category “Retail Women's Clothing.” The at least one merchant category of the merchants in the second set 306 can be stored in the corresponding record (r) 202 in the second set 306, or can be derived from the merchant identifier of the corresponding merchant in the second set 306, or a combination thereof.

Subsets and sub-subsets can be similarly created. For example, a first subset 308 of the first set 304 can include portions of the transaction data 302 in which the merchant M(j) 102 engaged in the transactions therein and the date on which each of the transactions in the subset 308 occurred within a reporting time period (e.g., January 2004 to March of 2004). The subset 308 can be created by first creating the first set 304 then filtering a portion of the transaction data 302 in the first set 304 based on matching the date of each of the corresponding transactions in the first set 304 to the reporting time period. Alternatively, the subset 308 can be created by first filtering the transaction data 302 by matching the date of each of the corresponding transactions in the transaction data 302 to the reporting time period, then filtering those transactions in the transaction data 302 such that each of the transactions in the subset 308 was conducted by the merchant M(j) 102. In yet another alternative, both filtering processes can be done at the same time. Stated another way, the filtering processes can occur in a serial or parallel fashion.

Other set, subset, sub-subset, and so forth can be created, wherein the transaction data 302 is filtered based on information therein, such as the information in field (f) 204 or a combination of fields (f, f+1, f+n) 204. For example, a sub-subset can include the transactions in the transaction data 302 in which: the merchant M(j) 102 was engaged in the transaction with a single consumer having an account within the payment processing system, the account number of the account being “4234567890123456,” the transactions occurred in June of 2002, and each purchase was for a product having a Stock Keeping Unit (SKU) in the range of 011000189012 to 011000189099. A data point within the sub-subset can be: a transaction between Ms. Mary Smith and a Niemen Marcus® store 334 located in Manhattan, N.Y. on Jun. 11, 2002 for a Joseph Abbud silk tie payable upon the account “4234567890123456.”

Similarly, the portion of the transaction data 302 in a set (e.g., the first set 304 or the second set 306) or subset (e.g., the first subset 308 or the second subset 310) may be for the transactions that have occurred on a type of account within the payment processing system. For example the first set 304 may contain the transaction data for the transactions of the merchant M(j) 102 that have occurred during the months of July 2002 to December 2002. The first subset 308 may be for the transaction data in which the merchant M(j) 102 engaged in the transactions that occurred in the month of July 2002 each of which is payable upon the accounts within the payment processing system that have “423455” as the first six digits of a corresponding account identifier, thereby distinguishing the account as a credit type account.

The transaction data in the set, subsets, or sub-subsets may be for the transactions that are payable upon such accounts as: prepaid accounts, credit accounts; debit accounts; corporate accounts; non-corporate accounts; small business accounts; government accounts; Flexible Spending Accounts, Health Savings Account, or a combination thereof. For example, the transactions within the subset 310 may each be payable upon a corresponding corporate account.

The portion of the transaction data 302 in a set or sub-set may be filtered based on a demographic of the consumers engaged in the transactions. For example, it may be known that the consumer with the credit card number “4234567890123456” is a female with a mailing address located in Naples, Fla. This demographic information may be stored in corresponding records (1−r) 202 wherein the consumer is engaged in the corresponding transactions stored in the records (1−r) 202. Alternatively, or in combination, the account identifier of the corresponding consumer may be usable to retrieve the demographic data of the consumer from another database.

The MBT can aggregate corresponding information in each of sets, subsets, sub-subsets of the transaction data 302. The MBT can aggregate by algorithmically combining the information therein. For example, the MBT may algorithmically combine the amount of each of the transactions within the first set 304 by adding each amount of funds transferred to the merchant M(j) 102 in the corresponding transactions in the first set 304, such as adding each amount of funds in the “amount field” stored in the field (1) 204. In another example, the MBT can add each amount of funds transferred to the merchants M(j, j+1, . . . j+n) 102 stored in the sub-subset 310.

Data aggregation may permit a merchant M(j) to learn about their customers and their performance relative to peer group merchants. Instead of providing data on an individual customer, the data provided will preferably be aggregated so as to obscure the spending of any particular customer. In particular, MBT may aggregate transaction records 202 to generate an aggregate transaction record 202 for a merchant's customers. Aggregation may also be used to obtain insight into purchasing behavior of the merchant's customers as a group. Some individual customers may, however, at their sole option opt-in and authorize MBT to provide their transaction records 202 to one or more merchants. Some of the customer may choose to opt-in, in exchange for an incentive.

In another implementation, the MBT can algorithmically combine components of the transaction data without creating the sets or subsets of the transaction data 302. For example, each of the transactions within the database 108 can be interrogated to determine if a match to a criteria exists. If there is a match, the component is algorithmically combined. To illustrate, each of the transactions in the database 108 may be analyzed to determine whether the merchant M(j) 102 conducted the corresponding transaction in the database 108. The determination can be made by matching the merchant identifier of the merchant M(j) 102 with that of the transaction within the database 108 being analyzed. If a match exists, then the amount of funds transferred to the merchant M(j) 102 for the analyzed transaction can be added to a running total.

The MBT can provide an output to the merchant M(j) 102 conveying trends in the transaction data. In one implementation, the MBT shows a performance of the merchant M(j) 102 compared to that of a plurality of merchants that are each classified in at least one merchant category that the merchant M(j) 102 is also classified under (hereinafter, the “peer”). While the report may show a comparison of the average sales statistics for the merchant M(j) 102 relative to that of its peers as determined from the merchant category, the report withholds peer identities from the merchant for whom the report was prepared. The performance of the peer may either include or exclude the performance of the merchant M(j) 102 depending on a desired output.

The output may be on printed paper or the MBT can render the output upon a merchant computer screen linked to the computer hosting the MBT. Moreover, changes in the sales performance can be highlighted using a color scheme wherein the performance as compared to the peers of the merchant can be color coded. For example, when the merchant M(j) 102 is leading its peers in sales for a reporting month by a 10 percent margin, the statistics for that month may be in a green colored font. On the other hand, when the merchant M(j) 102 is lagging its peers in sales by 10 percent, the statistics for that month may be in a red colored font. Similarly, changes in metric performance from one period to the next can be color coded. For example, where the merchant has gained in market share by 10 percent over the past month, the statistic for the month may be in blue while a loss in market share of 10 percent may be in purple. Different gray scales, colors, line formation, or fonts can be used to display the metric. Moreover, for electronically rendered reports, the intensity may be dynamically presented wherein the intensity may have a rate of change while being displayed, such as a number being faded in and out while the merchant M(j) 102 is viewing the report. Audible cues similarly varying in intensity corresponding to value are similarly contemplated for the rendered report.

The MBT can provide trend information within classifications of accounts within the payment processing system, wherein the account classification is defined by a chronological sequence of corresponding transactions payable upon the corresponding account of a corresponding consumer.

For example, the report may show trends in the following account classifications:

1. “Existing Customer:” a consumer that has engaged in at least two transactions upon an account with a first merchant (e.g., the merchant M(j) 102 or its peers) within the same category as that of the merchant M(j) 102 including a first transaction during a first time period and a second transaction during a second time period that is subsequent to the first time period;

2. “New Customer:” a consumer that has engaged in at least one transaction upon an account with a first merchant within the category of the merchant M(j) 102 during a second time period but not during the first time period;

3. “Lost Customer” a consumer that has engaged in at least one transaction upon an account with a first merchant within the category of the merchant M(j) 102 during a first time period but not during a second time period; and

4. “Lost to Competitor Customer”: a Lost Customer that further has engaged in at least one transaction upon an account in a second time period with a merchant different from the first merchant.

The table below illustrates how the account classifications can be designated based on a timeline if the first time period is from January 1st to March 31st and the second time period is from April 1st to June 30. In the table below, “X” denotes that a sample consumer has engaged in one of the transactions with the first merchant:

| A sample | | | | | | |
|---|---|---|---|---|---|---|
| consumer/account | | | | | | |
| can be | Janu- | Febru- | | | | |
| classified as: | ary | ary | March | April | May | June |
| Existing | X | | X | | X | |
| Customer | | | | | | |
| New Customer | | | | | | X |
| Lost Customer | | | X | | | |
| Lost to | | X | | | X | |
| Competitor | | | | | (with a 2nd | |
| Customer | | | | | merchant) | |

For example, the first subset 308 may be for a “Lost to Competitor Customer” which can include a portion of the transaction data 302 wherein the corresponding consumers charged a credit card to pay the merchant M(j) 102 during the month of March of 2002, did not charge the same credit card to pay the merchant M(j) 102 during the month of June of 2002, but did charge the same credit card in the month of June 2002 to pay a merchant M(j+1) 102 that is one of the peers of the merchant M(j) 102. A single data point within the first subset 304 for the “Lost to Competitor Customer” can be: a transaction of Ms. Mary Smith with a Niemen Marcus® store in Niagara Falls, N.Y. occurring on Jun. 4, 2002 on account number “4234567890123456” wherein Ms. Mary Smith engage in another transaction on the credit card with a Saks Fifth Avenue® store in July 2002 but does not engage in another transaction on the credit card with the Niemen Marcus® store in Niagara Falls in July of 2002.

The respective time periods (e.g., the first time period or the second time period) that determines whether one of the consumers is one of the “Existing Customers,” “New Customers,” “Lost Customers,” or “Lost to Competitor Customers” may be preset. For example, the values for the time periods may be set by the MBTP 106 or the merchant M(j) 102. To illustrate, the first time period may be set by the merchant M(j) 102 as four (4) months and the second time period may be preset by the merchant M(j) 102 at the next three (3) months. In other examples, the first time period may be the hours from 12:00 PM-4:00 PM and the second time period may be the hours from 6:00 PM-10:00 PM.

Merchants may use the account classification to initiate marketing campaigns. In an example, the MBT may create alerts to inform merchant M(j) 102 when a certain percentage of their customers fall within a particular account classification. For example, MBT may determine that within the past six months 25% of a hotel's customers have moved into the classification “Lost to Competitor.” MBT may also track with which competitors merchant M(j)'s 102 customers are now shopping. For example, MBT may inform a department store that a certain customers have moved into the classification “Lost to Competitor,” that 53% of those “Lost” customers are now shopping at discount retailers, and that 47% are now shopping at other department stores.

Those skilled in the art can appreciate other account classifications. For example, Active Customers may be consumers that use a corresponding account to conduct transactions with any of the merchants, whether the merchant is one of the peers of the merchant M(j) 102 or not; Inactive Customers may be consumers that are not Lost Customers but have not engaged in a transaction within a time period that is shorter than the second time period; or Returning Customers may be consumers that were once Lost Customers but have recently engaged in a transaction with one of the peers of the merchant M(j) 102.

The report may show trends in other metrics as well, such as:

1. An “Overall Sales:” total amount of funds for transfer (e.g., authorized to be transferred, actually transferred, or a combination) over a first reporting time period to the merchant M(j) 102 or to peers of the merchant M(j) 102, respectively;

2. A “Ticket Amount:” an amount of funds for transfer in one of the transactions between the consumer and the corresponding merchant;

3. A “Wallet Share:” a total amount of funds transferred from a first account to the merchant M(j) 102 over a first reporting time period as compared to the total amount of funds transferred from the first account to the peers of the merchant M(j) 102 over the first reporting time period.

4. A “Gap Value:” a difference between a first metric (e.g., for the merchant M(j) 102) and a second metric (e.g., for the peers of the merchant M(j) 102).

In some examples, wallet share analysis may be used to determine what portion of their customers' spend within the peer group a merchant has captured. For instance, the MBT may process transaction records 202 to determine a total amount of spend by merchant M(j)'s customers (e.g., within a predetermined amount of time). The MBT may also process transaction records 202 to determine an average total amount of spend within a merchant peer group. The MBT may divide merchant M(j)'s total by the peer group average to determine merchant M(j)'s proportion of spend within the peer group. For example, merchant M(j) may be a clothing retailer. The MBT may determine how much merchant M(j)'s customer spent during a particular month. The MBT may similarly determine an average total spend at peer group merchants during the same month. The MBT may divide the merchant M(j)'s total by the peer group average to determine merchant M(j)'s proportion of spend within the peer group.

In a more detailed example, an airline may desire to obtain data comparing how much of their customer's spend they have captured and the portion spent on other airlines. The MBT may retrieve transaction records 202 of the airline and the other airlines over a one year time period. The MBT may process the transaction records of the airline and determine that the airline's customers spend $576 on average for airfare with the airline and an average total of $1,800 for airfare within the peer group. Thus, the airline has captured, on average, 32% of their customers' expenditures on airfare during the year.

In another example, the wallet share analysis may compare different types of merchants within a same segment. For instance, a restaurant peer group may be divided into three different types (1) fine dining restaurants, (2) casual sit-down restaurant, and (3) quick service restaurants. The MBT may process transaction records to determine a total spend for each type individually and in the segment. The MBT may divide the total for each type by the aggregate total to determine the market share of each type (e.g., 10% fine dining, 34% causal, 56% quick service).

In some examples, the MBT may determine a gap value based on one or more of metrics for customer visit frequency and/or financial information (e.g., ticket amount, sales growth, market share, etc.). For instance, a gap value may indicate how frequently a customer visits merchant M(j) 102 relative to its peers at certain time periods. In an example, merchant M(j) 102 may use the MBT to request analysis of their performance at certain time periods relative to peer merchants. A time period may be one or more minutes, hours, days, weeks, months, years. For example, merchant M(j) 102 may want to know how their sales performance compares to the sales performance of peer merchants on weekdays between the hours of 6:00 AM-9:00 AM. In another example, merchant M(j) 102 may want to know how their customer's average ticket on the first Monday of the month compares to their competitors.

For the specified time period, the MBT may query database 108 to retrieve records 202 having a time and/or hour field that occurs within the specified time period. The MBT may then process data from the transaction records 202 associated with merchant M(j) 102 to generate a metric for merchant M(j) 102, and similarly process transaction records 202 associated with the peer merchants to generate a metric for the peer merchants. The MBT may also provide an indicator (e.g., color coding) to reflect how the customer's average ticket of merchant M(j) 102 compares to the average ticket of peer merchants.

Using the visit frequency example from above, the MBT may determine a total number of different transaction records 202 associated with merchant M(j) 102 and how many unique users made a purchase during the specified time period. The MBT may then divide the total by the number of unique users to determine an average visit frequency for the merchant's customers. The MBT may make a similar determination for the peer merchants and then average the results to determine an average visit frequency for the peer group. The MBT may then forward the averages to the merchant along with an indicator of how merchant M(j) 102 compares to peer merchants. For example, a quick service restaurant may want to compare how frequently their customers visit as compared to peer merchants.

Using the average ticket example from above, the MBT may process ticket data from the transaction records 202 associated with merchant M(j) 102 to determine an average ticket for the merchant's transactions occurring within the specified time period. The MBT may similarly determine an average ticket for merchants within the peer group. The MBT may then forward the averages to the merchant along with an indicator of how merchant M(j) 102 compares to peer merchants.

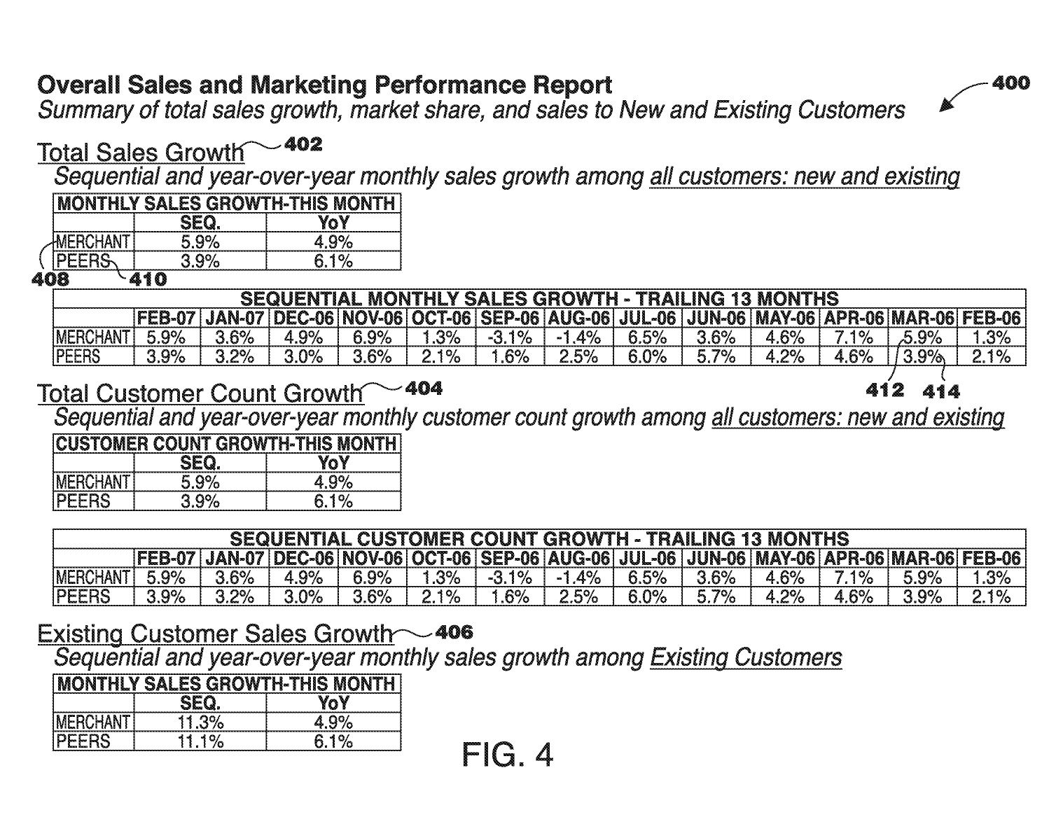

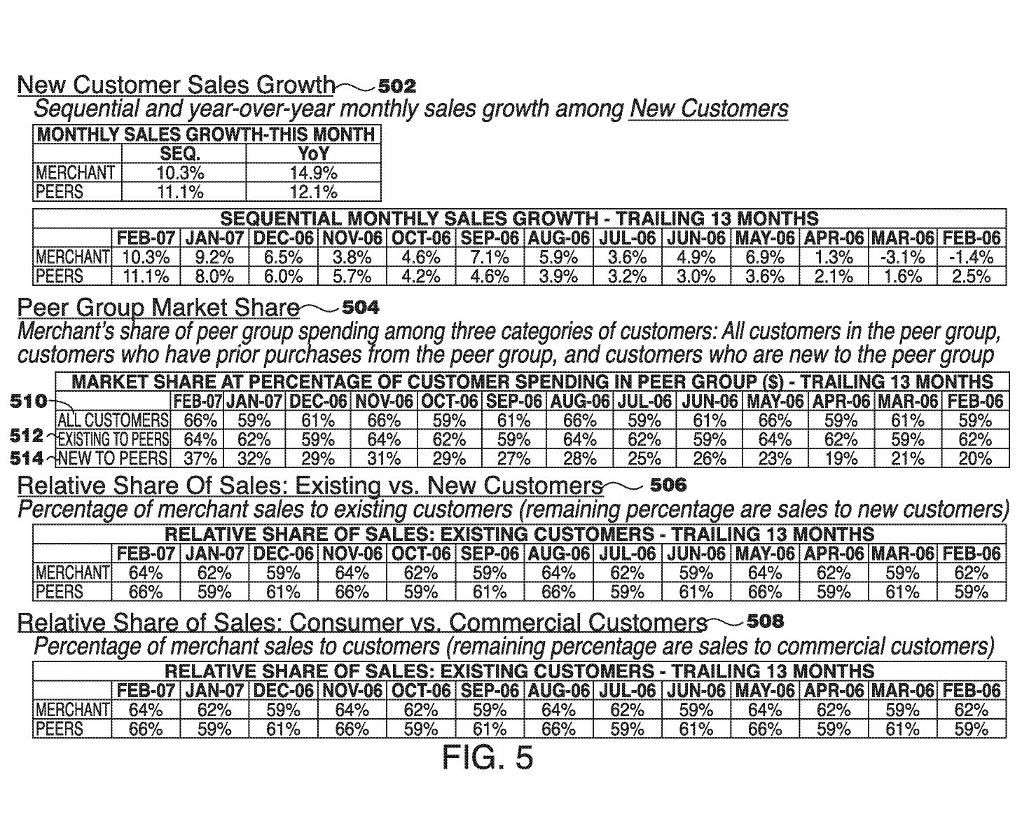

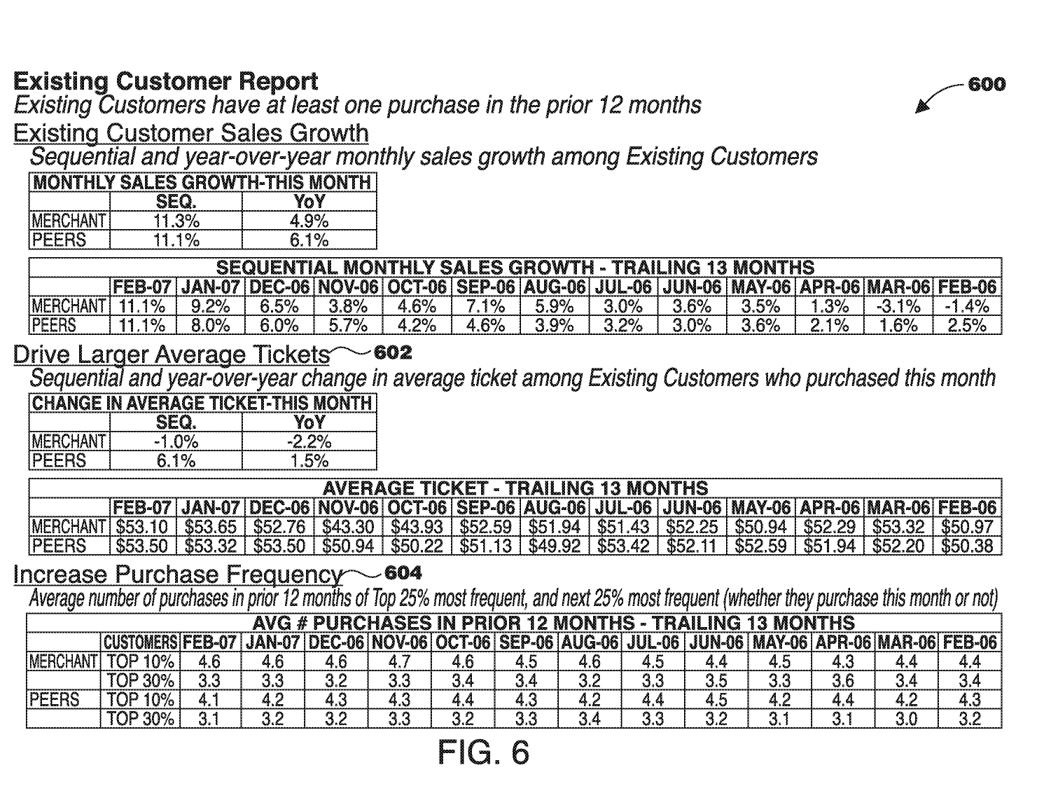

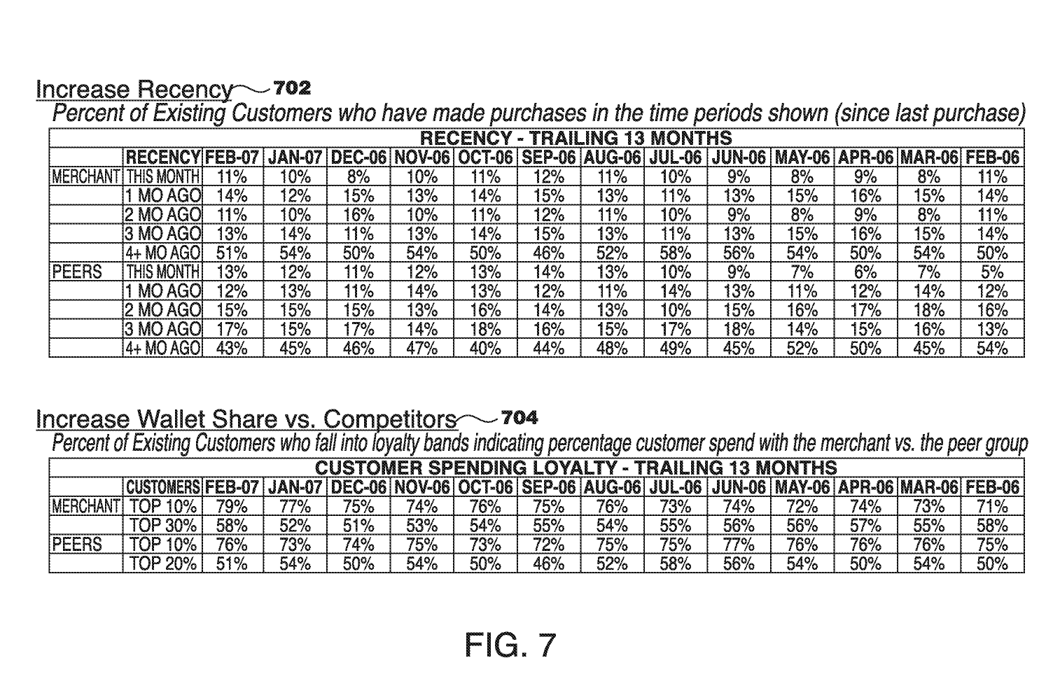

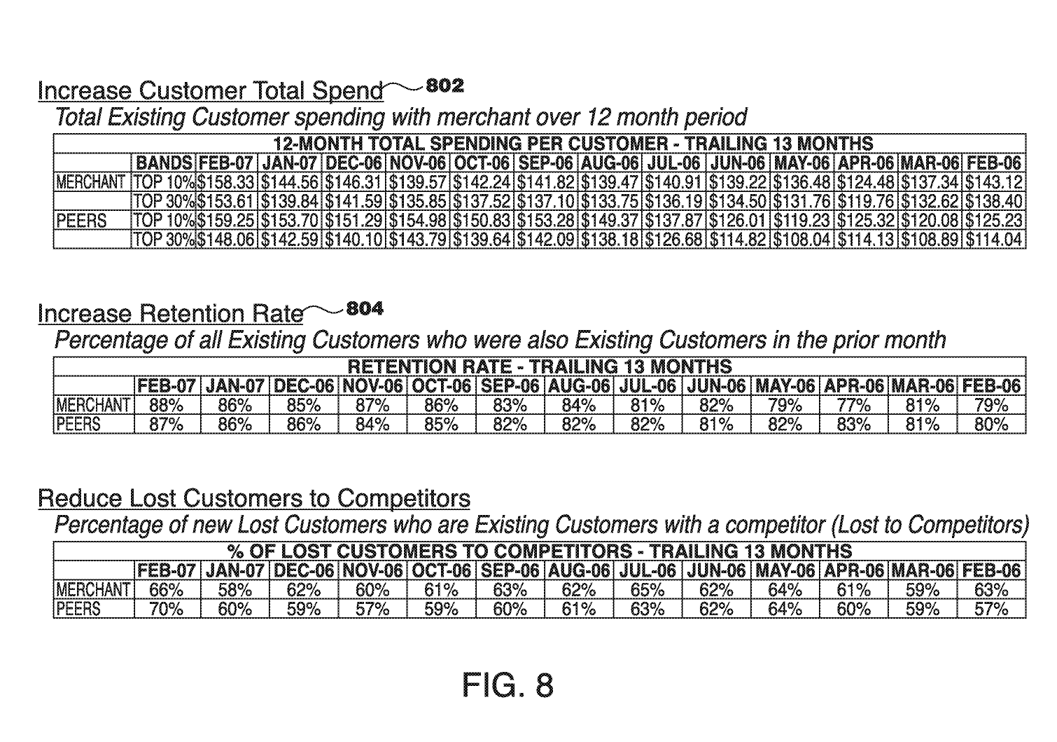

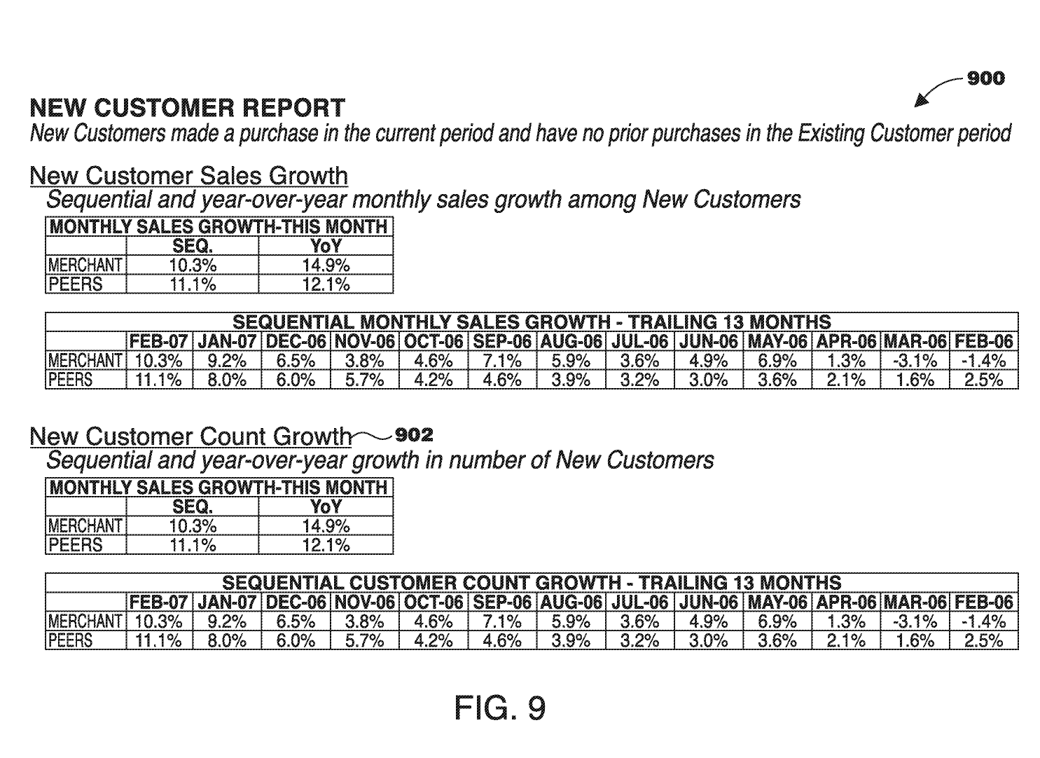

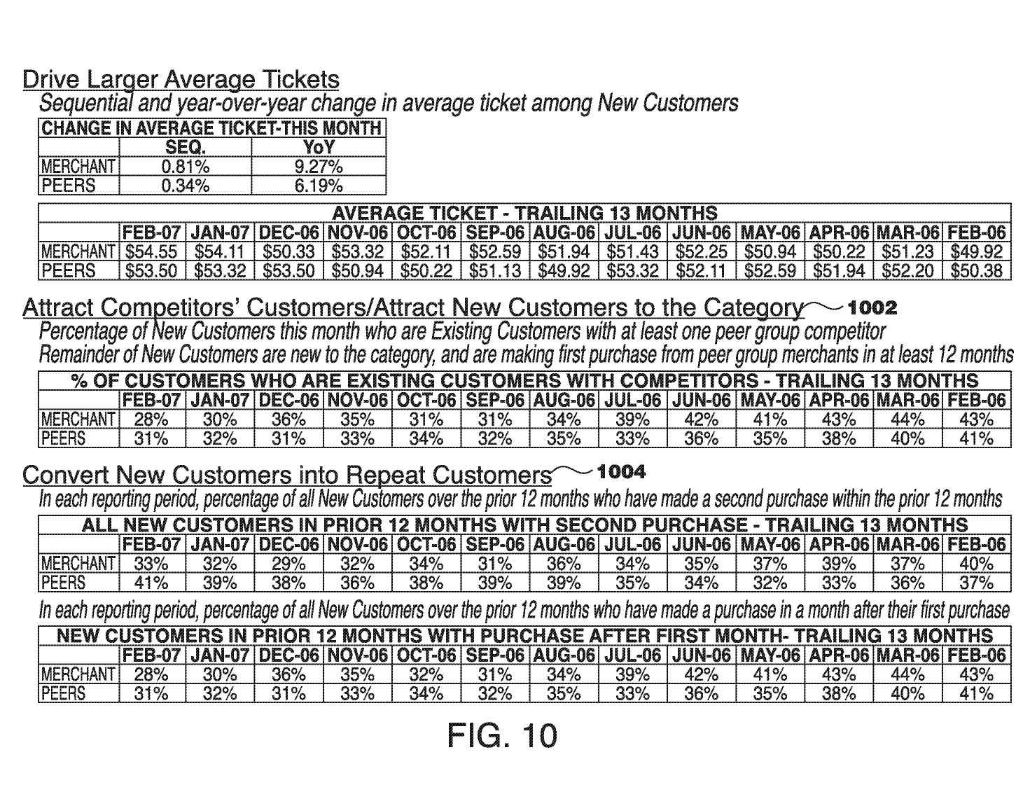

Referring to FIGS. 4-10, each depicts one or more screen shots of portions of a corresponding report rendered in a predetermined electronic format. The performance of the merchant M(j) 102 in comparison to its peers is illustrated in different reports such as a Overall Sales and Marketing Performance Report 400 (FIG. 4 through 5), an Existing Customer Report 600 (FIG. 6 through 8), and a New Customer Report 900 (FIG. 9 through 10). Each report displays metrics reflecting the performance of the merchant M(j) 102 in comparison to its peers along with an indicator of how merchant M(j) 102 compares to peer merchants.

The reports may have the following metrics:

The Overall Sales and Marketing Performance Report 400
1. Total Sales Growth 402:
   a. Total Sales Growth of the merchant M(j) 102 (shown in FIG. 4 as 408)—A percentage change in Overall Sales of the merchant M(j) 102 from New Customers and Existing Customers for a first reporting time period as compared with a second reporting time period (e.g., a current month compared to a past month); and
   b. Overall Sales of peers of the merchant M(j) 102 (shown in FIG. 4 as 410)—A percentage change in Overall Sales of peers of the merchant M(j) 102 from New Customers and Existing Customers for the first reporting time period as compared with the second reporting time period.
2. Total Customer Count Growth 404: a frequency of use of each of the accounts used in the transactions with each of the merchant M(j) 102 and its peers, respectively. In the example shown in FIG. 4, in March of 2006, the merchant M(j) 102 had an increase of 5.9% (shown at 412) in the number of consumers that engaged in the transactions with the merchant M(j) 102 as compared to the number of consumers that engaged in the transactions with the merchant M(j) 102 in the month of February 2006. The peers of the merchant M(j) 102 had only a 3.9% (shown at 414) increase in the number of consumers that engaged in the transactions with corresponding peers of the merchants M(j) 102 in March 2006 as compared to the number of consumers that engaged in the transactions with corresponding peers of the merchant M(j) 102 in the month of February 2006. Consequently, there was a gap decrease 416 in between the merchant M(j) 102 and its peers in March (having a Gap Value of 5.9−3.9=2) as compared to February 2006 (having a Gap Value of 7.1−4.6=2.5).
3. Exiting Customer Sales Growth 406: the Total Sales Growth among Existing Customers.
4. New Customer Sales Growth 502: the Total Sales Growth among New Customers.
5. Peer Group Market Share 504: A percentage share of the merchant M(j) 102 of the Overall Sales (e.g., total sales of the merchant M(j) 102 and its peers) for each of the following consumers:
   a. All Customers 510 (e.g., Existing Customers, New Customers, and Lost Customers);
   b. Existing to Peers 512: Existing Customers, wherein the first merchant is any of the merchants that are peers of the merchant M(j) 102;
   c. New to Peers 514: New Customers, wherein the first merchant is any of the merchants that are peers of the merchant M(j) 102;
This metric may show the performance of the merchant M(j) 102 as well as that of its peers. For example, an increase in the Existing Customers for the peers of the merchant M(j) 102 might be due to superior products sold among the peers of the merchant M(j) 102, loyalty programs, or competitive discounts.
6. Relative Share of Sales Existing vs. New Customers 506: the Total Sales Growth of the Existing Customers as compared to New Customers (e.g., the Existing Customer Sales Growth reported for a month can be divided by the Total Sales Growth reported for the same month).
7. Relative Share of Sales: Consumer v. Commercial Customers 508: A percentage of the Overall Sales of the merchant M(j) 102 and peers of the merchant M(j) 102, respectively, from corresponding noncommercial accounts as compared to the Overall Sales from corresponding commercial accounts.

The Existing Customer Report 600
1. Drive Larger Average Tickets 602: A sequential percentage change in an average of the Ticket Amount among Existing Customers who purchased in a reporting month for each of the merchant M(j) 102 and its peers, respectively.
2. Increase Purchase Frequency 604: an average number of the transactions over the first reporting period for a percentage of accounts based on the frequency of use of the account or an average of corresponding Ticket Amounts (e.g., the top 10% of the accounts frequently used in the transactions with each of the merchant M(j) 102 and peers of the merchant M(j) 102, respectively).
3. Increase Recency 702: a percentage of the Existing Customers whose most recent purchase is within an enumerated time period (e.g., if 17% of Existing Customers fall into a “3 months ago” time period, then 17% of the Existing Customers of the merchant M(j) 102 have made a purchased from the merchant M(j) 102 within in the past 3 months).
4. Increase Wallet Share vs. Competitors 704: the Wallet Share for each of the merchant M(j) 102 and its peers, respectively, that come from a portion of the Existing Customers (e.g., the Top 10% of the Existing Customers that spend more with the merchant M(j) 102 as compared to peers of the merchant M(j) 102).
5. Increase Customer Total Spend 802: Overall Sales over a reporting time period for a percentage of the Existing Customers based on the Wallet Share of each of the merchant M(j) 102 and peers of the merchant M(j) 102, respectively.
6. Increase Retention Rate 804: A percentage of Existing Customers of each of the merchant M(j) 102 and peers of the merchant M(j) 102, respectively, for the first reporting time period who were each also Existing Customers of each of the merchant M(j) 102 and peers of the merchant M(j) 102 for the second reporting time period.

The New Customer Report 900
1. New Customer Count Growth 902: a percentage growth from the first reporting time period compared to the second reporting time period of a frequency of use of each of the accounts of New Customers that were used in the transactions with each of the merchant M(j) 102 and its peers, respectively.
2. Attract Competitors' Customers/Attract New Customers to the Category 1002: a percentage of New Customers for the first reporting time period who are also Existing Customers with at least one of the peers of the merchant M(j) 102 that is not the merchant M(j) 102.
3. Convert New Customers into Repeat Customers 1004: a percentage of New Customers during the first reporting time period that conducted a second transaction during the second reporting time period for each of the merchant M(j) 102 and peers of the merchant M(j) 102, respectively.

The reports described above may be linked to one another. For example, the Total Sales Growth 402 may be electronically displayed to the merchant M(j) 102. Portions within the report may contain hyperlinks to other portions of the same report or to other reports. For example, if the Existing Customer Report 600 renders the metric Total Sales Growth 402 showing that the merchant M(j) 102 is leading its peers, the merchant M(j) 102 may be able to “drill” into more detail in the various reports (e.g., via selecting the hyperlink having an address of a portion of the Existing Customer Report 600) to identify the possible drivers of the performance of the merchant M(j) 102. By accessing the other reports, the merchant M(j) 102 may discover that the lead is due to an increase in sales with New Customers rather than with Existing Customers or that the lead is due to the transactions that have been payable upon non-corporate accounts rather than corporate accounts.

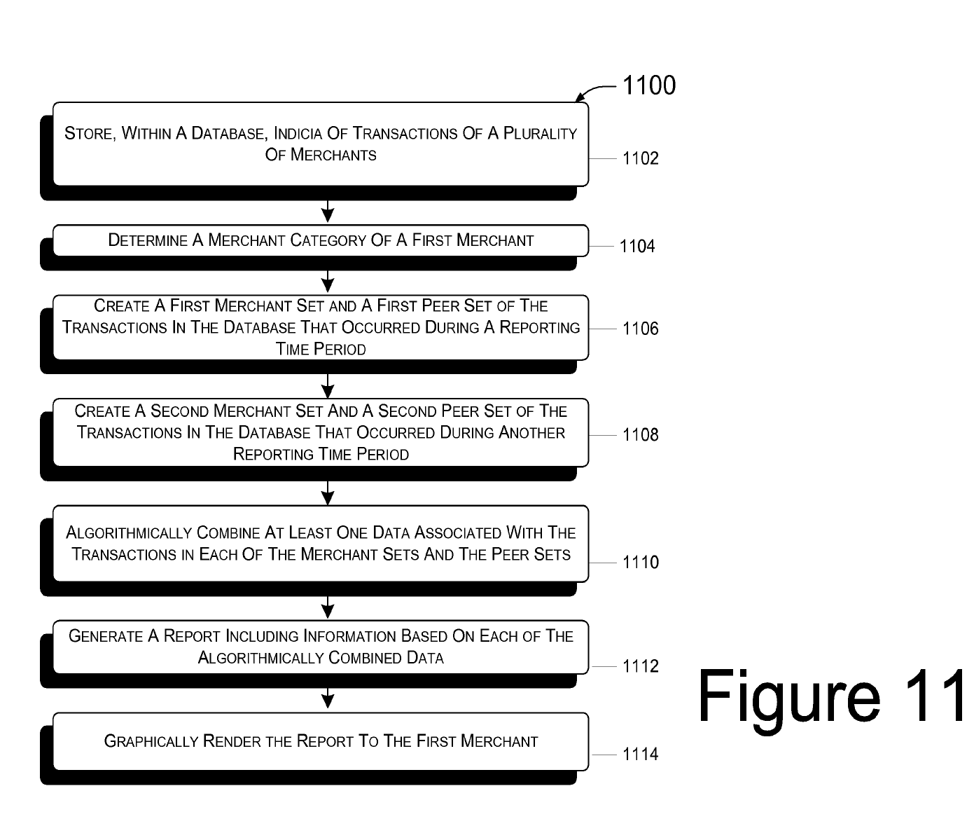

Referring to FIG. 11, a flow chart of an exemplary method 1100 for graphically rending the report to the merchant M(j) 102 starts at a step 1102. At the step 1102, indicia of the transactions (e.g., the transaction data) of the plurality of the merchants is stored within the database (e.g., the database 108). The indicia of the transactions can include: a date on which each of the transactions occurred; an amount of funds that can be transferred from the account of the corresponding consumer (e.g., Existing Customers, New Customers, Lost Customers, Lost to competitor Customers, or a combination thereof); the merchant identifier of the corresponding merchant receiving the amount of funds (e.g., merchant M(j) 102 or one of its peers); at least one merchant category of the corresponding merchant receiving the amount of funds; a total amount of funds transferred to a plurality of merchants that are peers of the merchant M(j) 102; or a combination thereof. At step 1104, the merchant category of a first of the merchants, such as the merchant M(j) 102 is determined. For example, the merchant identifier of the merchant M(j) 102 may be used to determine at least one merchant category of the merchant M(j) 102.

At step 1106, for the transactions that have occurred within a first reporting time period, a first merchant set and a first peer set are created. The transactions in the first merchant set 304 are each with the merchant M(j) 102. For example, each of the transactions in the first merchant set may have the merchant identifier of the merchant M(j) 102. Similarly, the transactions in the first peer set are each with the peers of the merchant M(j) 102, which may include the merchant M(j) 102. As stated previously, the peers of the merchant M(j) 102 are each in at least one of the merchant categories under which the merchant M(j) 102 is classified. In one implementation, the corresponding merchant identifiers stored in association with each of the transactions is matched against the determined at least one merchant category of the merchant M(j) 102. If there is a match, the transactions having the match are filtered into the first peer set.

At step 1108, for the transactions that have occurred within a second reporting time period, a second merchant set and a second peer set are created. Other such merchant sets and peer sets can also be created, each of which contains the transactions that occurred during a corresponding reporting time period.

At step 1110, the transaction data associated with respective transactions within each of the merchant sets (e.g., the first, second, or successive merchant sets) and the peer sets (e.g., the first, second, or successive peer sets), respectively, is algorithmically combined. The data may be information within one of the fields (f) 204, derived from the information within one of the fields (f) 204, or a combination thereof. For example, each Ticket Amount within the first merchant set may be added to equal the Overall Sales of the merchant M(j) 102 during the first reporting time period. Alternatively, or in combination, the frequency of use of a first account of a first consumer may be combined. For example, if the first consumer uses the account with the account identifier “4234567890123456” to engage in five (5) transactions with the merchant M(j) 102 during the first reporting time period, then the algorithmic combination would equal five (5).

The algorithmic combination may be a sum calculation, a mean calculation, a median calculation, a mode calculation, a percentage of the sum calculation, or a combination thereof, for example. To illustrate, the Overall Sales for the merchants that are peers of the merchant M(j) 102 may first be averaged, then a percentage difference in the average can be calculated and shown in the report (e.g., the average of the Overall Sales of peers for the second reporting time period can be compared to that of the first reporting time period). Other forms of algorithm combinations are known to one of ordinary skill in the art, such as, weighted summations, percentage change of transaction data values over several time periods, or results from data mining analysis.

In one implementation, a percentage difference in Overall Sales of the merchant M(j) 102 and its peers is calculated for a series of sequential pairs of adjacent reporting time periods. For example, the percentage difference in the Overall Sales of merchant M(j) 102 may be compared to its peers for three of the pairs of adjacent reporting time periods defined as: March 2006 and April 2006; April 2006 and May 2006; and May 2006 and June 2006.

At step 1112, a report is generated so as to include information based on the algorithmically combined data. At step 1114, the report is graphically rendered, such as to a computer display.

In another implementation, data is accumulated from transactions, such as cashless transactions made payable upon a corresponding account within the payment processing system. A percentage change in the transactions of the merchant is calculated for each of a current time period (e.g., the first reporting time period) and a past time period (e.g., the second reporting time period). The percentage change in the transactions of the peers of the merchant is also calculated for each of the current time period and the past time period. The report is rendered showing each of the percentage change for the merchant and for its peers, whereby the rendered report identifies growth in cashless sales of the merchant within the category compared to the cashless sales of the peers of the merchant within the category. The Gap Value for the percentage change for the merchant compared to the peers of the merchant can also be calculated and rendered in the report in an audible and/or visual intensity corresponding to the Gap Value.

The report may show a number of transactions on a single account, a plurality of accounts, or a classification of accounts. For example, the number of transactions on one of the accounts during the reporting time period can be counted for each of the merchant M(j) 102 and its peers for rendering in the report. Alternatively, or in combination, the counting can occur for the accounts in a corresponding account classification and reported, such as counting the number of times corresponding Existing Customers shop with the merchant M(j) 102 versus the number of times corresponding Existing Customers shop with its peers.

To illustrate, the merchant M(j) 102 may be American Broadcasting Company® Television Network (“ABC”). ABC may use an Internet browser loaded on a merchant computer within a local area network of ABC. The Internet browser may communicate, via the Internet, with the host computer of the MBTP 106 that may be a transaction handler of a payment processing system. For example, ABC may form a transmission addressed to the transaction handler requesting one of the reports. ABC may conduct an interactive session with the MBT so as to perform the computer implemented method 1100 as seen in FIG. 11 or a variation thereof.

During the interactive session, ABC may indicate that its wants an electronic version of the Overall Sales and Marketing Performance Report 400 for the consumers that have used a corresponding corporate account within the payment processing system to pay ABC for services and to pay its peers. ABC may specify that the report should show various metrics for the year 2000. ABC may indicate to the transaction handler that its peers include: National Broadcasting Company® Television Network (“NBC”) and other “television networks.”

The MBT may interrogate the database 108 and sum each Ticket Amount of the transactions that: occurred in the year 2000; were conducted with ABC; and were payable upon a corresponding account that has “42356” as the first six digits of a corresponding account identifier (e.g., thereby identifying the account as a corporate account).

Similarly, the MBT may interrogate the database 108 to determine the Overall Sales of the peers of ABC. The MBT may determine the category of ABC to be “Television Network” “Streamcast Merchants,” “Broadcaster,” or “Television Services.” The MBT may sum each Ticket Amount of the transactions that: occurred in the year 2000; were conducted with the peers of ABC; and were payable upon a corresponding account that has “42356” as the first six digits of the corresponding account identifier. Alternatively, the MBT may have stored the Overall Sales for the peers of ABC in the database 108 such that individual Ticket Amounts are not stored in the database 108. Other metrics can be similarly calculated for the requested Overall Sales and Marketing Performance Report 400. Thereafter, the MBT can render the metrics for each of ABC and its peers, including color coding for Gap Value leads and lags of ABC compared to its peers.

### The Payment Processing System

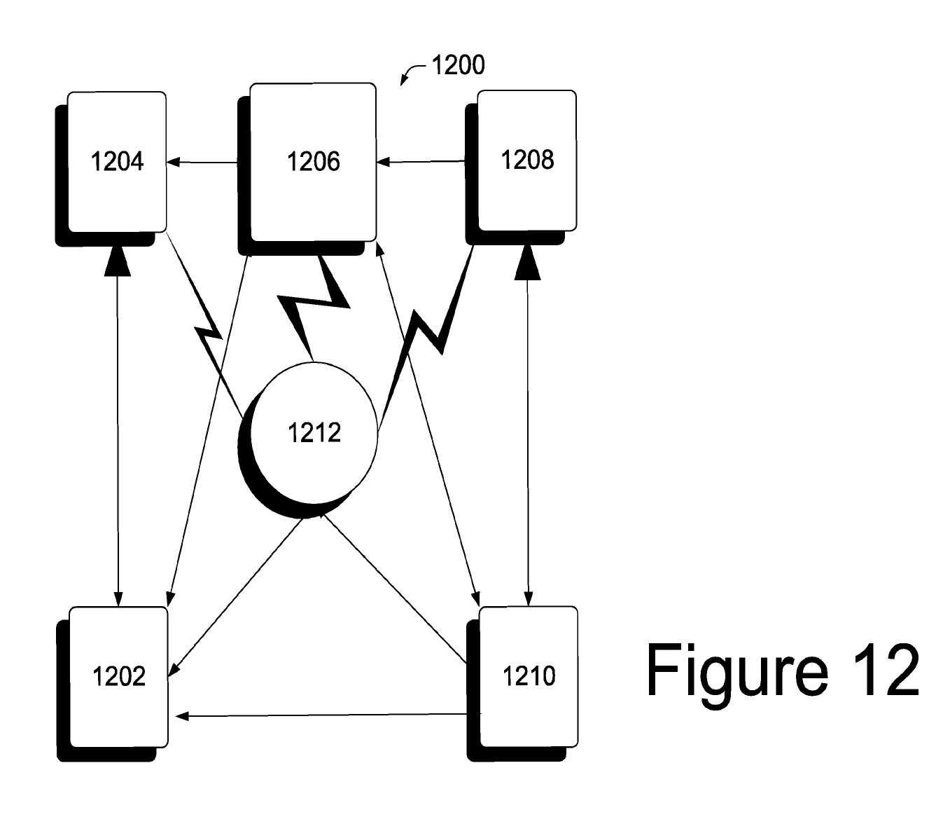

As background information for the foregoing description, as will be readily understood by persons of ordinary skill in payment systems, the transaction in the payment system can include participation from different entities that are each a component of the payment processing system. An exemplary payment processing system is depicted in FIG. 12 as the payment processing system 1200. The payment processing system 1200 includes an issuer 1204 such as the issuer; a transaction handler 1206, such as the transaction handler; an acquirer 1208 such as the acquirer; a merchant 1210 such as the merchant M(j) 102; and a consumer 1202 such as the consumer. The acquirer 1208 and the issuer 1204 can communicate through the transaction handler 1206. The merchant 1210 may utilize at least one of the POS(m) 112 that can communicate with the acquirer 1208, the transaction handler 1206, or the issuer 1204. Thus, the POS(m) 112 is in operative communication with the payment processing system 1200.

Typically, the transaction begins with the consumer 1202 presenting a corresponding account number of the account, such as through the use of a computer terminal or a portable consumer device 1212, to the merchant 1210 to initiate an exchange for a good or service. The consumer 1202 may be an individual or a corporate entity. The consumer 1202 may be an account holder of the account issued by the issuer 1204 such as a joint account holder of the account or a person having access to the account such as an employee of a corporate entity having access to a corporate account. The portable consumer device 1212 may include a payment card, a gift card, a smartcard, a smart media, a payroll card, a health care card, a wrist band, a machine readable medium containing account information, a keychain device such as the SPEEDPASS® commercially available from ExxonMobil Corporation or a supermarket discount card, a cellular phone, personal digital assistant, a pager, a security card, a computer, an access card, a wireless terminal, or a transponder, for example. The portable consumer device 1212 may include a volatile or a non-volatile memory to store information such as the account number or a name of the account holder.

The merchant 1210 may use an acceptance point device, such as the POS(m) 112, to obtain account information, such as the indicator for the account (e.g., the account number of the account), from the portable consumer device 1212. The portable consumer device 1212 may interface with the POS(m) 112 using a mechanism including any suitable electrical, magnetic, or optical interfacing system such as a contactless system using radio frequency, a magnetic field recognition system, or a contact system such as a magnetic stripe reader. The POS(m) 112 sends a transaction authorization request to the issuer 1204 of the portable consumer device 1212. Alternatively, or in combination, the portable consumer device 1212 may communicate with the issuer 1204, the transaction handler 1206, or the acquirer 1208.

The issuer 1204 may submit an authorized response for the transaction via the transaction handler 1206. Authorization includes the issuer 1204, or the transaction handler 1206 on behalf of the issuer 1204, authorizing the transaction in connection with instructions of the issuer 1204, such as through the use of business rules. The transaction handler 1206 may maintain a log or history of authorized transactions. Once approved, the merchant 1210 can record the authorization and allow the consumer 1202 to receive the good or service.

The merchant 1210 may, at discrete periods, such as the end of the day, submit a list of authorized transactions to the acquirer 1208 or other components of the payment processing system 1200 for clearing and settling. The transaction handler 1206 may compare the submitted authorized transaction list with its own log of authorized transactions. If a match is found, the transaction handler 1206 may route the clearing and settling request from the corresponding acquirer 1208 to the corresponding issuer 1204 involved in each transaction. Once the acquirer 1208 receives the payment of the transaction from the issuer 1204, it can forward the payment to the merchant 1210 less any transaction costs, such as fees.

There may be intermittent steps in the foregoing process, some of which may occur simultaneously. For example, the acquirer 1208 can initiate the clearing and settling process, which can result in payment to the acquirer 1208 for the amount of the transaction. Alternatively, or in combination, the acquirer 1208 may request from the transaction handler 1206 that the transaction be cleared and settled.

It should be understood implementations can be in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two. In some examples, software may be implemented as computer readable instructions stored on at least one non-transitory medium (e.g., memory), where the instructions, when executed by at least one processor, cause at least one apparatus (e.g., at least one computer) to perform the functions described herein.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A computer implemented method comprising:
accessing a database comprising a plurality of transaction records, each of the records comprising transaction data on a purchase transaction;
determining, by a processor, a first subset of the transaction records that occur within a predetermined time period and are associated with a first merchant;
determining, by the processor, a second subset of the transaction records that occur within the predetermined time period and are associated with a merchant peer group;
processing, by the processor, the first subset of transaction records to determine a first metric for the first merchant;
processing the second subset of transaction records to determine a second metric for the merchant peer group; and
comparing the first metric to the second metric to indicate performance of the first merchant relative to performance of the merchant peer group.

2. The method of claim 1, wherein each of the transaction records comprise at least one of an hour field and a date field.

3. The method of claim 1, further comprising
determining a percentage change in the first metric within the predetermined time period as compared with a past time period; and
determining a percentage change in the second metric within the predetermined time period as compared with the past time period.

4. The method of claim 1, further comprising determining that a customer made a purchase at the first merchant within the predetermined time period and a peer merchant of the merchant peer group at a time period occurring before or after the predetermined time period.

5. The method of claim 4, further comprising classifying the customer in an account loyalty classification based on frequency of purchases from the peer merchant.

6. The method of claim 1, wherein each of the first metric and the second metric is a visit frequency.

7. The method of claim 1, wherein each of the first metric and the second metric is a financial metric.

8. An apparatus comprising:
at least one processor; and
at least one memory storing computer readable instructions that, when executed, cause the apparatus at least to perform:
accessing a database comprising a plurality of transaction records, each of the records comprising transaction data on a purchase transaction;
determining a first subset of the transaction records that occur within a predetermined time period and are associated with a first merchant;
determining a second subset of the transaction records that occur within the predetermined time period and are associated with a merchant peer group;
processing the first subset of transaction records to determine a first metric for the first merchant;
processing the second subset of transaction records to determine a second metric for the merchant peer group; and
comparing the first metric to the second metric to indicate performance of the first merchant relative to performance of the merchant peer group.

9. The apparatus of claim 8, wherein each of the transaction records comprise at least one of an hour field and a date field.

10. The apparatus of claim 8, wherein the instructions, when executed, further cause the apparatus at least to perform:
determining a percentage change in the first metric within the predetermined time period as compared with a past time period; and
determining a percentage change in the second metric within the predetermined time period as compared with the past time period.

11. The apparatus of claim 8, wherein the instructions, when executed, further cause the apparatus at least to perform determining that a customer made a purchase at the first merchant within the predetermined time period and a peer merchant of the merchant peer group at a time period occurring before or after the predetermined time period.

12. The apparatus of claim 11, wherein the instructions, when executed, further cause the apparatus at least to perform classifying the customer in an account loyalty classification based on frequency of purchases from the peer merchant.

13. The apparatus of claim 8, wherein each of the first metric and the second metric is a visit frequency.

14. The apparatus of claim 8, wherein each of the first metric and the second metric is a financial metric.

15. A non-transitory computer readable medium storing instructions that, when executed, cause an apparatus at least to perform:
accessing a database comprising a plurality of transaction records, each of the records comprising transaction data on a purchase transaction;
determining a first subset of the transaction records that occur within a predetermined time period and are associated with a first merchant;
determining a second subset of the transaction records that occur within the predetermined time period and are associated with a merchant peer group;
processing the first subset of transaction records to determine a first metric for the first merchant;
processing the second subset of transaction records to determine a second metric for the merchant peer group; and
comparing the first metric to the second metric to indicate performance of the first merchant relative to performance of the merchant peer group.

16. The computer readable medium of claim 15, wherein each of the transaction records comprise at least one of an hour field and a date field.

17. The computer readable medium of claim 15, wherein the instructions, when executed, further cause the apparatus at least to perform:
determining a percentage change in the first metric within the predetermined time period as compared with a past time period; and
determining a percentage change in the second metric within the predetermined time period as compared with the past time period.

18. The computer readable medium of claim 15, wherein the instructions, when executed, further cause the apparatus at least to perform determining that a customer made a purchase at the first merchant within the predetermined time period and a peer merchant of the merchant peer group at a time period occurring before or after the predetermined time period.

19. The computer readable medium of claim 18, wherein the instructions, when executed, further cause the apparatus at least to perform classifying the customer in an account loyalty classification based on frequency of purchases from the peer merchant.

20. The computer readable medium of claim 15, wherein each of the first metric and the second metric is a visit frequency or a financial metric.
